(19) United States
(12) Patent Application Publication
(10) Pub. No.: US 2004/0010775 A1
(43) Pub. Date: Jan. 15, 2004

(54) Method, system and program product for reconfiguration of pooled objects

(75) Inventors: Moshe E. Matsa, Cambridge, MA (US); Julius Q. Quiaot, San Jose, CA (US); Christopher R. Vincent, Arlington, MA (US)

Correspondence Address: Floyd A. Gonzalez, IBM Corporation, 2455 South Road, P386, Poughkeepsie, NY, 12601, US

(73) Assignee: International Business Machines Corporation, Armonk, NY

(21) Appl. No.: 10/194,829

(22) Filed: Jul. 12, 2002

(51) Int. Cl. G06F 9/44

(52) U.S. Cl. 717/116; 717/120

(57) ABSTRACT

A method, system and program product for control of regeneration of pooled objects in an object oriented programming environment. Objects in the pool are regenerated according to various schemes that define dependencies that need to be observed in scheduling a regeneration. According to the invention, an object that is marked “reserved” (in use) can be deferred for regeneration so as not to disrupt an active application for example.

The present invention is related to an object oriented programming computer system and more specifically to managing objects in a pool of objects.

### BACKGROUND OF THE INVENTION

The World Wide Web (The Web) is a popular computer networking platform today with millions of people daily using it for a wide variety of applications from personal e-mail and research “web surfing” to highly sophisticated business and scientific uses. The web was developed to make the use of the Internet simple and easy to use. The concept was to provide Browser programs at user (client) personal computers (PCs) to interpret information from host servers using HTML and graphic files. The Internet provided the communication means to interconnect web clients and servers.

FIG. 1 shows an example computer system useful for Web or Internet Peer-to-Peer network communications and executing object oriented programs. The system is comprised of a processor 106 for executing program instructions fetched from memory 105. Storage Media 107 (magnetic or optical) is used to hold programs and data that is not currently being operated on by the processor 106. The base computer optionally has peripheral devices attached to it to supply a user interface. Typically peripherals include a Display 102, Keyboard 104 and a network connection 108. Optionally, a mouse 103, printer/Scanner 110 are also connected to the example computer system. Programs 111 held in Storage Media 107 is paged into memory 105 for processor execution. Programs 111 include an operating system and applications for example. Object oriented programs are programs that generate program objects during run time. These objects are held in memory 105 for execution by the processor.

FIG. 2 shows a plurality of computer systems of various designs interconnected by local and Internet networks. Any or all of the computers 201-206, 208 in FIG. 2 could employ Object Pooling 100.

In object oriented programming (OOP), objects are program entities that are created at run time. For example, an application might create a client object that needs a connection object in order to connect to network resources. The creation and destruction of the connection object delays the execution of the application. A connection object is needed for each client object that wants to connect to network resources.

Object pooling overcomes the overhead of creating and destroying objects by allowing many clients to reuse objects (in a pool FIG. 3). Object pooling is described in the “Developer's Guide”: Using Object Pools document from iplanet at Sun Microsystems, Inc.

The use of Object pooling solves potential limited-resource issues. Limited resources can cause performance bottlenecks when there are not enough resources to meet clients' demands. Connections to networked resources, such as databases, require non-trivial amounts of time to create and destroy. In high-throughput applications, client objects must wait for a connection object to become available, creating a bottleneck in the flow of the application.

Through the use of object pooling, a plurality of clients can share a limited resource (such as a connection), using it only when they need it. In this way, the performance cost of creating and destroying the resource is reduced. This benefit applies to any client of the pool-enabled extension.

Extension writers and server administrators work together as follows To enable object pooling. In Netscape Extension Builder Designer for example, an extension writer adds object pooling decorations. These tasks are described in “Developer's Guide”: Using Object Pools from iPlanet.

In the generated source code, an extension writer completes method stubs related to object pooling. These tasks are described in “Developer's Guide”: Using Object Pools document from iplanet at Sun Microsystems.

Object pooling FIG. 3 involves the concepts of a pool of objects (Object Pool), Virtual 311 and Physical Objects 314, Clients 310 and, an Object Pool Manger 312.

An object pool is a set of limited resources (such as connections) that can be “Reserved” for use by clients and then returned to the pool (for probable reuse) when the object is no longer needed. Reserving returning pooled objects avoids the overhead of separately creating and destroying an object each time a client requests it. Multiple object pools can be used. For example, one object pool might contain database connection objects, and another pool might contain CICS connection objects.

Without object pooling, whenever a client 310 of an extension (typically an application) requests an object, a physical object 314 is created and destroyed when no longer needed. On the other hand, when an extension uses object pooling, the application's request for a poolable object generates a virtual object 311 instead. The virtual object supports all the methods of the requested object, but the application sees only the virtual object.

When an application calls an interface method from the virtual object 311, the virtual object's implementation requests a physical object 314 from the pool and delegates the request to the physical object. When the request is complete, the extension returns the physical object 314 to the Object Pool Manager for use by other virtual objects.

In the context of object pooling, a client 310 is the code that calls into the extension. The client is typically an application but can also be another extension. The extension requests objects, and the Object Pool Manager 312 makes callbacks to the extension to determine how to fulfill the request.

The Object Pool Manager in the referenced document (“Developer's Guide”: Using Object Pools document from iplanet at Sun Microsystems.) is a service of Netscape Application Server. In response to clients' requests for objects, the Object Pool Manager 312 controls one or more pools by reserving and releasing the objects in the pool. The Object Pool Manager queues virtual objects' requests for physical objects; marks physical objects as either “Free” or “Reserved”; attempts to create physical objects when necessary and destroys physical objects in a pool, based on idle time or usage limits.

FIG. 3 shows the interrelationship between a pool-enabled extension and the key components of object pooling:

1. The client of an extension calls an interface method on the virtual object. 301

2. The virtual object's implementation reserves a matching physical object from a named pool. 302

3. The method call is delegated to the physical object. 303

4. When the method call is completed, the physical object is returned to the appropriate pool for use by other virtual objects. The Object Pool Manager uses a timer thread that periodically releases unused physical objects after a timeout.

### SUMMARY OF THE INVENTION

This patent is directed to object pooling in object oriented programming. In object pooling, objects are shared such that they need not be created and destroyed by applications as needed. Instead, virtual objects request physical objects from a pool. If the physical object doesn't exist, one is created. If it exists, it is marked “Reserved” while in use by the application. The physical object includes a special field which includes a version identifier.

It is therefore an object of the present invention to regenerate physical objects based on whether they are marked “free” or “reserved”;

It is another object of the present invention to selectively regenerate objects based on their version;

It is yet another object of the present invention to delay regeneration of objects based on constraints associated with that regeneration. For example, it may be desirable to allow current jobs to complete uninterrupted, operating on their original configuration. The objects associated with such jobs would be reconfigured when they are returned to the pool.

These and other objects will be apparent to one skilled in the art from the following detailed description of the invention taken in conjunction with the accompanying drawings in which:

### BRIEF DESCRIPTION OF THE DRAWINGS

FIG. 1 is a high level depiction of a computer system for executing program applications;

FIG. 2 is a high level depiction of a computer network employing a multiplicity of interconnected computer systems;

FIG. 3 is a diagram of a process overview for object pooling;

FIG. 4 is a diagram of an object pooling configuration with an object regeneration function of the present invention;

FIG. 5 is an example regeneration encoding scheme for an object according to the invention;

FIG. 6 is an example regeneration encoding scheme for multiple objects according to the invention;

FIG. 7 is a flowchart representing a preferred embodiment of the present invention;

FIG. 8 is a flowchart representing a preferred embodiment of creating a regeneration process;

FIG. 9 is a table representing an example regeneration criteria/process decision table according to the present invention; and

FIG. 10 is a flowchart representing an example regeneration execution process.

### DESCRIPTION OF THE PREFERRED EMBODIMENT

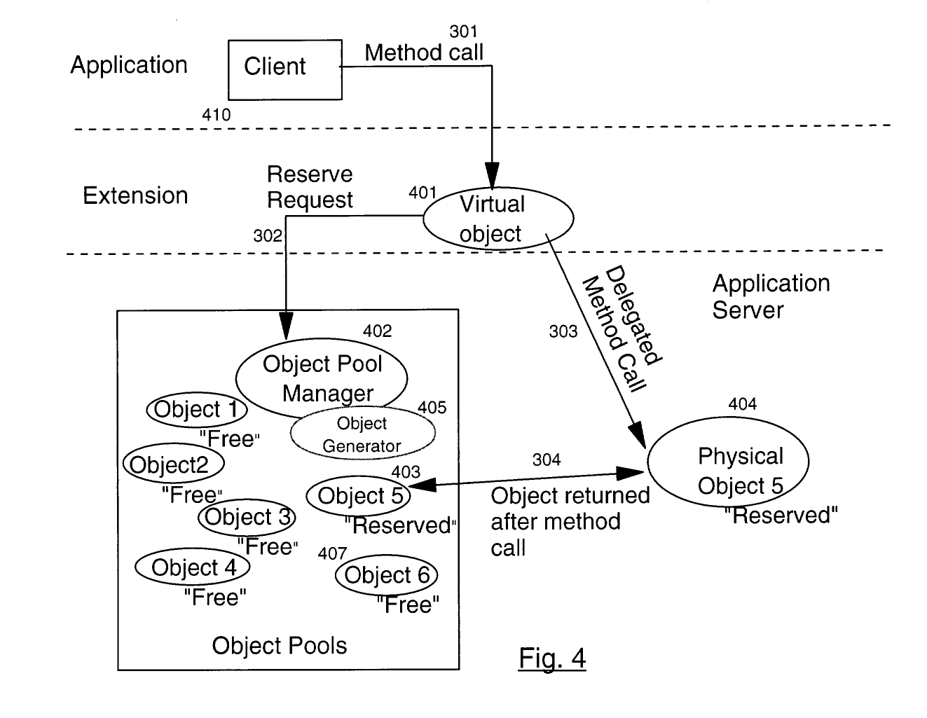

In a preferred embodiment FIG. 4, the virtual object 401 signals the object pool manager 402 that it needs a physical object 403. The physical object is created if it doesn't already exist and if it is marked “free”, it is marked “reserved” and made available to the virtual object (physical object 404). When it is not needed, the object is marked “free” and returned to the pool 403.

Thus, in an operating system many physical objects may be pooled. The pooled objects are under the control of the object pool manager 402. Some pooled objects may be available (marked “free”) and others in use (marked “reserved”). When the object data (configuration data) must be changed, the object pool manager 402 is informed and can decide either to fail (abort) all current jobs, recall those objects outstanding in the pool and start all new jobs with new configuration data or to let old jobs finish and hold all new jobs in a queue until all old jobs have finished and then change the objects' configuration.

In another embodiment, the object pool manager 402 would let old jobs proceed and immediately start new jobs with the new configuration data. The decision of how to proceed is made on the basis of the constraints of the reconfiguration, such as whether it is acceptable to work on assumptions from the old configuration (old pooled objects 403) while the new data is ready, whether it is acceptable to have different pooled objects 403 working on different configurations, and whether it is allowed to cancel a job once one of the pooled objects 404 has started working on it. With this design pattern, these decisions are abstracted into a object generator object 405 (which may be incorporated in the object pool manager object). The object generator 405 acts as a generator (regenerator) for all of the objects 403 404 in the pool.

In a preferred embodiment, as pooled objects 404 complete their jobs and returned to the pool 403, version numbers are used to determine whether reconfiguration is needed. If the version number of the target pooled object is less than a specified value, the pooled object is regenerated.

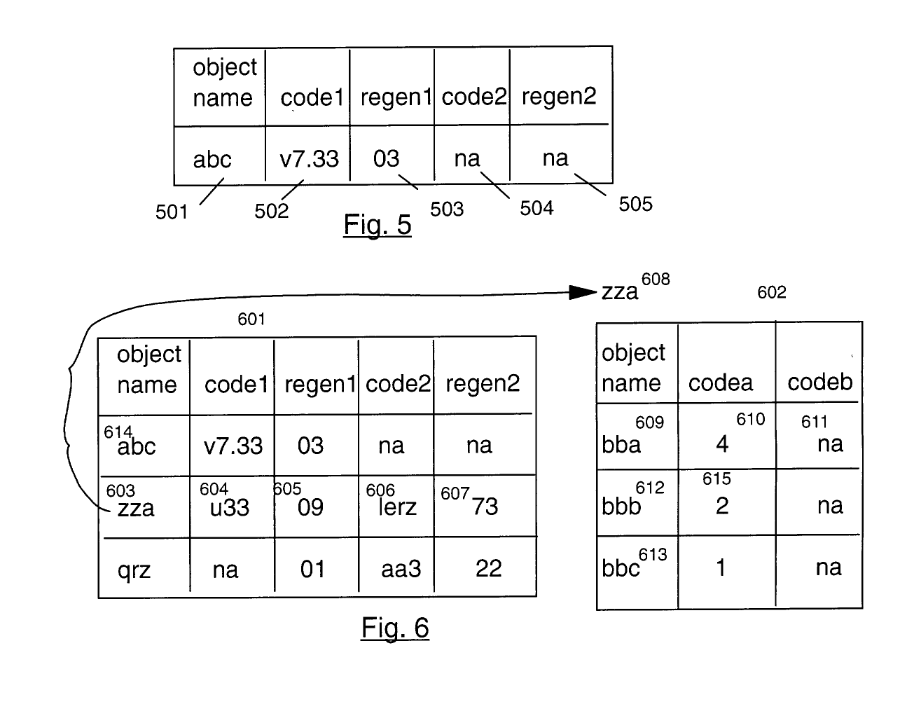

In one preferred embodiment, regeneration information is incorporated in each pooled object. When regeneration of an object is required, the object generator makes the determination of if, when and how to regenerate the object based on the object's regeneration information of FIG. 5. In the example embodiment, the object generator receives the regeneration information from the object (abc, v7.33, 03, -, -) 501-505 The information includes the object name 501 and various code fields 502 504. Each code field 502 504 has a regeneration field 50o3 505 associated with it. In the example, Object name ‘abc’ 501 includes code1=v7.33 502. The associated regeneration field regen1=03 503 tells the object generator 405 how to regenerate the object based on the code1 field 502. In this example, regen1 503 containing ‘03’ is interpreted as a requiring the regeneration to occure immediately for a “free” object and to abort the object for regeneration only if the version of the update is newer than code1 (>7.33). In this example coding, regen1 503 is the only coded field. In another preferred implementation of FIG. 5, code 2 504 would also be coded and regen2 505 would specify another regeneration function associated with code2 504. There are a great number of combinations of object regeneration criteria (codes) and methods (regen) that would be useful over and above the examples taught in the present invention. These would be obvious options to one skilled in the art practicing the present invention.

In another preferred embodiment, the object generator holds a table FIG. 6. The table comprises regeneration codes 604 606 for all pooled objects by name 603. In the example, regeneration for object named ‘abc’ 614 is coded as previously described in FIG. 5. Object name ‘zza’ 603 is coded as a pseudo object name where a separate list 602 of objects is provided under the name ‘zza’ 608 and the listed objects share the regeneration methods of ‘zza’ 604-607. In this example, objects in pseudo name ‘zza’ 603 all share regen method ‘09’ 605 and ‘73’ 607. Additionally, the objects of pseudo ‘zza’ 603 have other associated fields 610 611 in the pseudo table 602. In the example, object ‘bba’ 609, ‘bbb’ 612 and ‘bbc’ 613 are objects under pseudo ‘zza’ 603 608. In the ‘zza’ 608 table 602 each object has a codea field 610 615 that defines a hierarchy. If the regeneration is being performed for object ‘bbb’ 612 which has a code of ‘2’ 615, any object with a lower priority code (3 or higher) must be regenerated at the same time. Thus if ‘bbb’ 612 is to be regenerated, ‘bba’ 609 must be available for regeneration as well.

Objects needing regeneration are dependent on other objects in one embodiment. Such dependencies include sequence of regeneration (which objects to regenerate first, second . . . n^{th}), version number dependencies (regenerate objects of specific version number, version number range, higher/lower version number, version number relationship between codependent objects . . . ), simultaneous regeneration requirement (objects a, b, . . . m must be regenerated at the same time i.e. none can be in use during regeneration).

Objects are individually specified with regeneration criteria codes. Such regenerations require that the object is marked “free” (as object 6 407), that the object must be allowed to be returned to the pool before regeneration, a new object is generated that coexists with the original object until the original is “free”, at which time the old object is discarded, a new object is generated that coexists with the original object until a separate action enables all new versions of original objects at one time and discards all old versions.

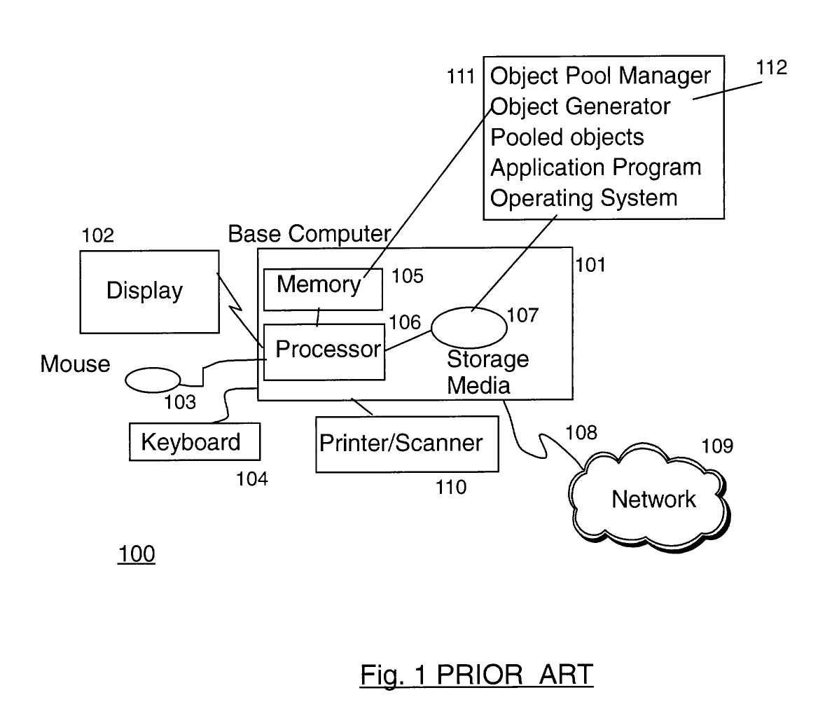

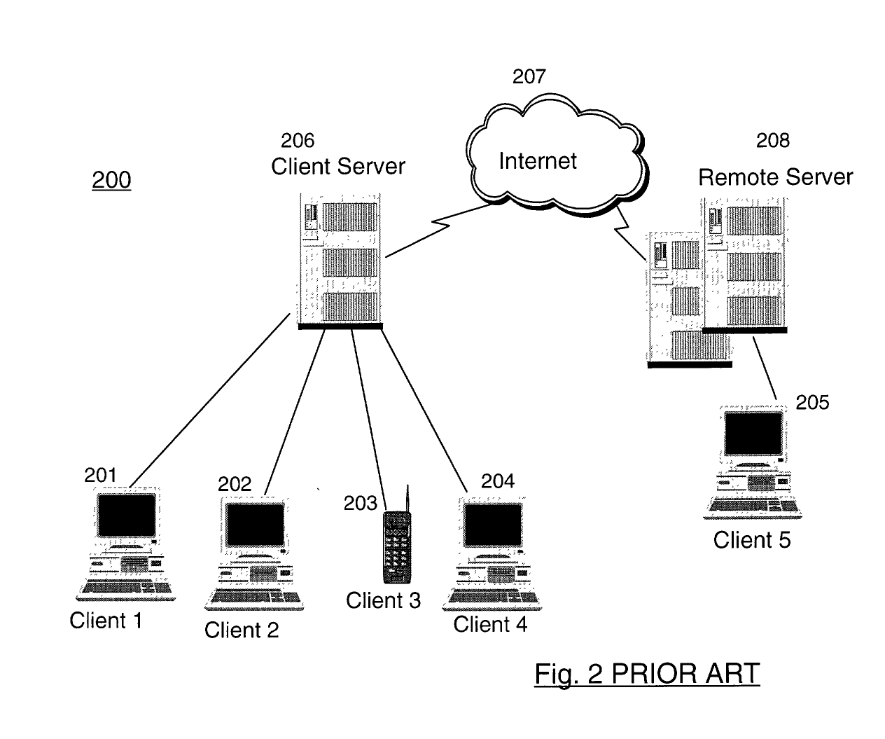

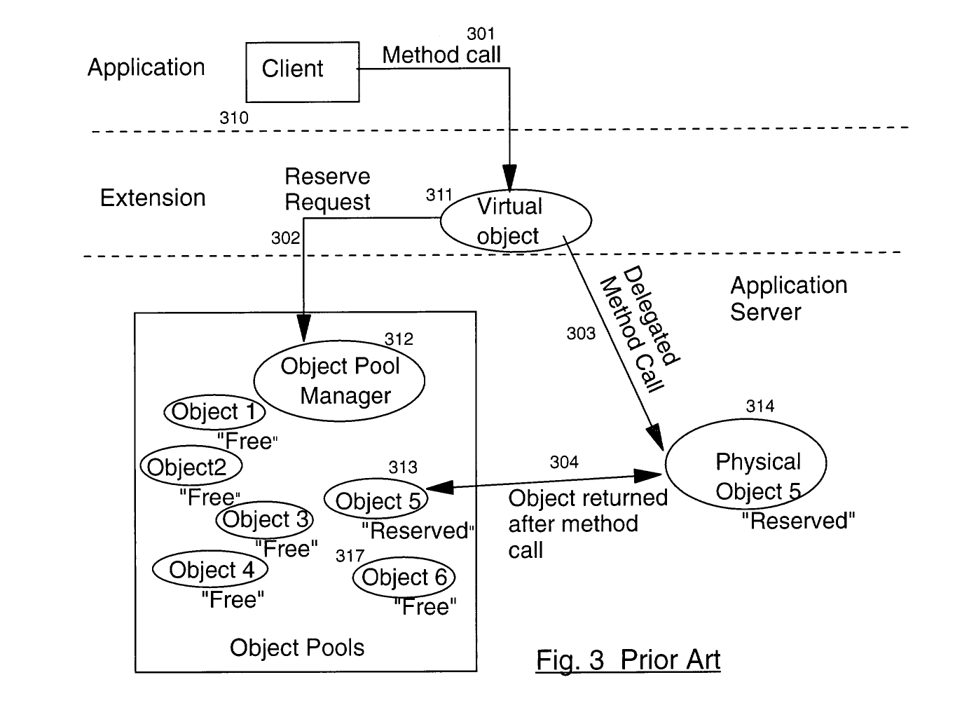

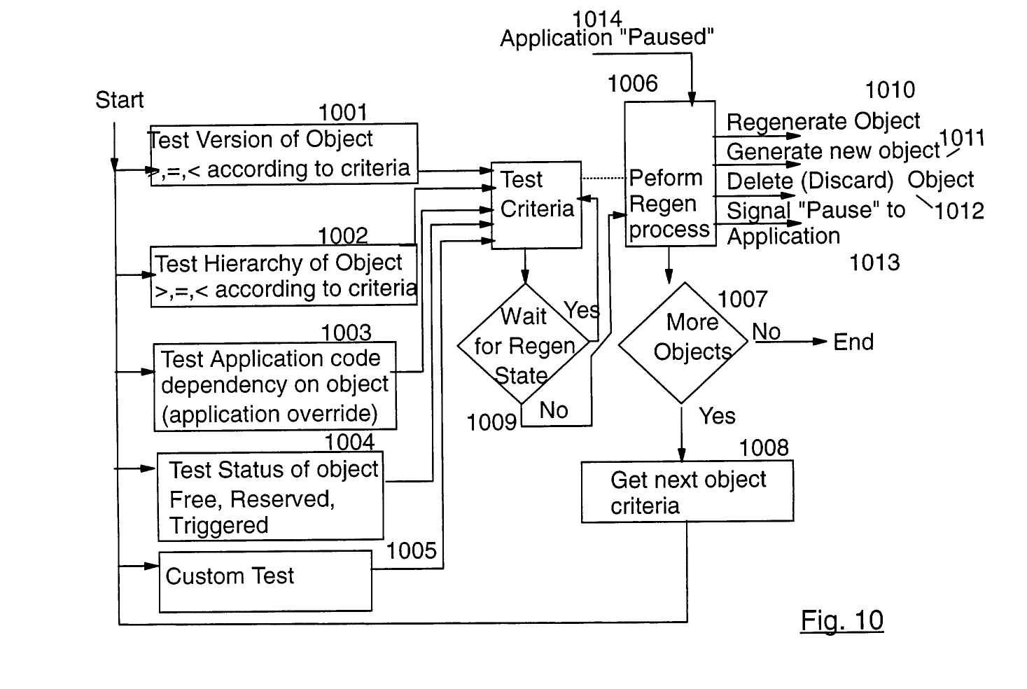

In one preferred embodiment, the application program FIG. 1 111 triggers a regenerate safe period such that the object to be regenerated is quiesced or paused to permit the regeneration without returning the object to the pool. The object regeneration program 405 signals the application to enter the pause state FIG. 10 1013, the application responds when it is paused with a special message 1014. When the object(s) in use by the application have been regenerated, the regeneration program signals the application to continue normal operation (removes pause signal 1013).

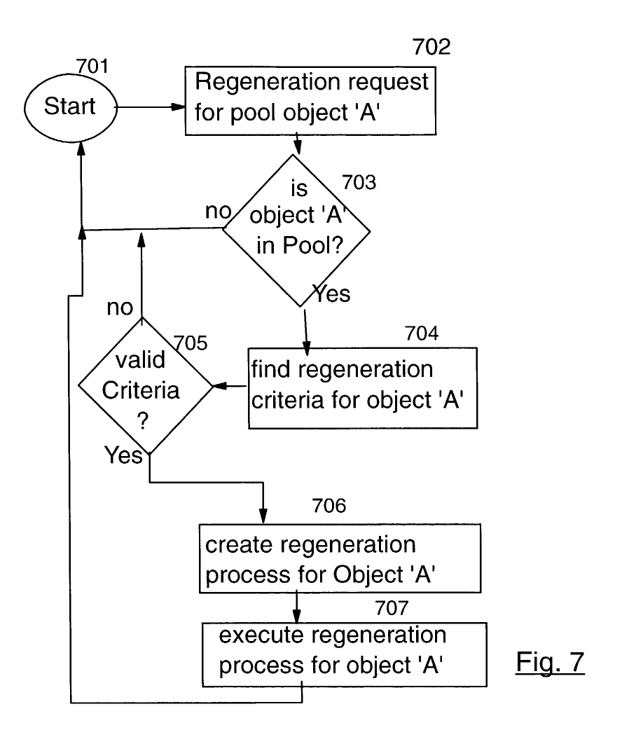

FIG. 7 demonstrates an example object generator regeneration process according to the present invention. A regeneration request is received 702 by the object Generator 405. If the object to be regenerated is in the pool 703, the regeneration criteria is retrieved 704. The criteria may be retrieved from the object itself or may be held in a separate table available to the object Generator. If the regeneration criteria is valid 705, a process is created 706 to regenerate the object according to the program status, object status and regeneration criteria. Finally, the regeneration process is executed 707 resulting in an immediate regeneration, a delayed regeneration, a generation of a new object with a delayed elimination of the original object or the like.

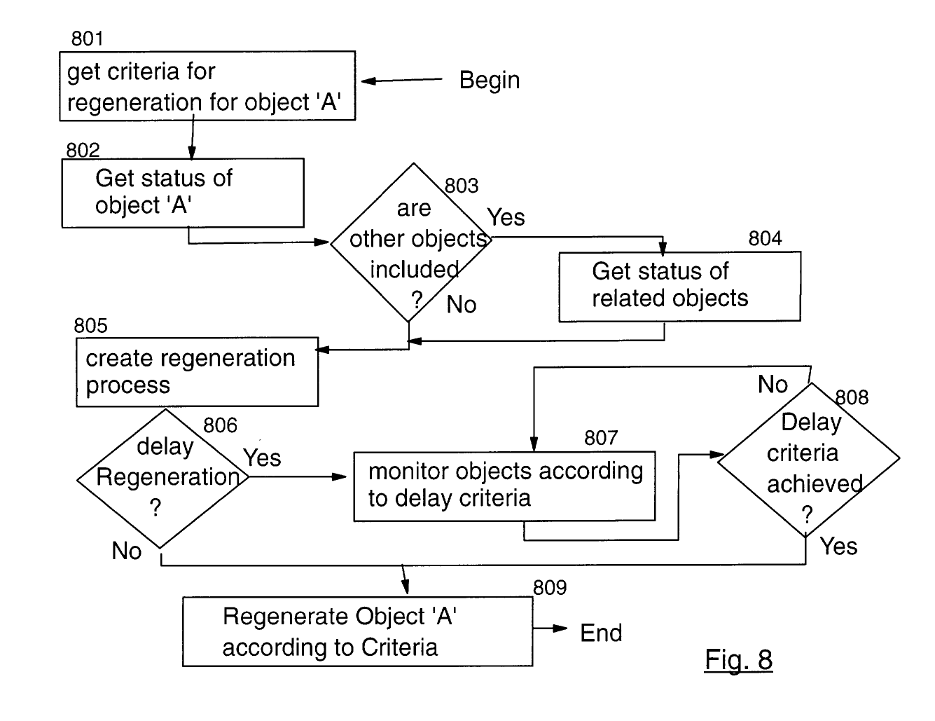

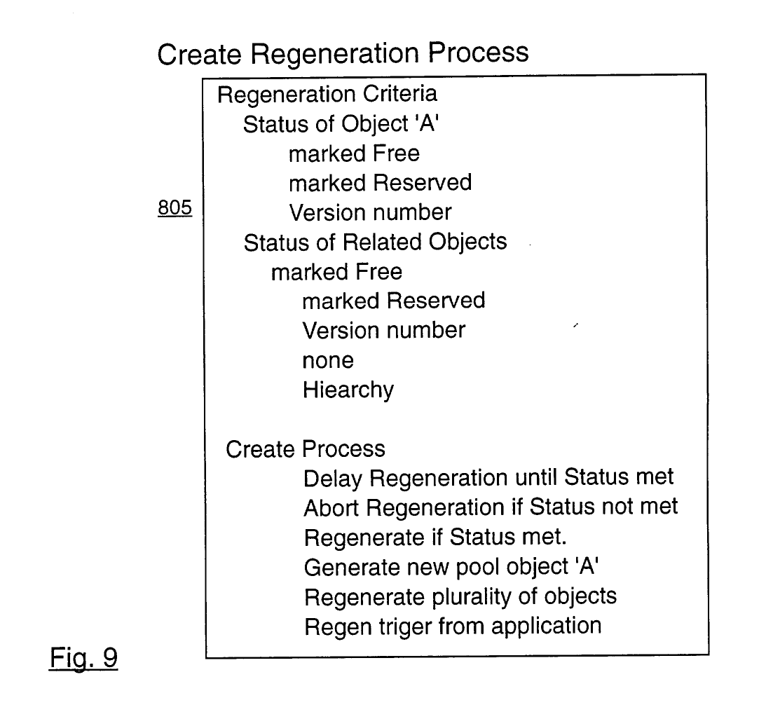

FIG. 8 is a depiction of a preferred embodiment of regeneration process creation 706. The criteria for the regeneration of the object is retrieved 801, the status of the object to be regenerated is retrieved 802. If 803 the regeneration is dependent on the status of other objects or if the regeneration is dependent on regeneration of other objects, the status of the other objects is retrieved 804. A regeneration process is created 805 based on the criteria associated with the object(s) included in the regeneration criteria. If 806 the status of system and object(s) included in the regeneration criteria indicate that regeneration must be postponed, the object generator monitors 807 the status until the status has been achieved 808. (The status might include a time-out indicator to prevent an endless loop). When the criteria and state agree, the regeneration is performed 809.

The create regeneration process in the preferred embodiment FIG. 9805, utilizes the status of the target object (marked “Free” or “Reserved”, version number for example), the status of related objects if any (are they marked “Free” or “Reserved”, their version number, any hierarchical relationship between related objects (what order to regenerate each object)), and the create process criteria (dependent in part on codes supplied by the object) (delay dependencies, abort conditions, regenerate if Status met, Generate new pool object, discard old pool object when “free”, application status signals (triggers)).

A regen process using the create regeneration process 805 is exemplified in FIG. 10. Various test criteria are designated according to predefined specifications for the object. Test criteria includes the object version related to a specified value 1001, The objects relative position in a hierarchy of objects 1002, the application program requirements for the object to not change 1003 (regeneration override), the status of the object 1004 or a customized criteria 1005 for the object. The test criteria may result in a delay of the regeneration or proceed directly to perform regeneration 1009. The regeneration may proceed immediately 1010 or regeneration may comprise generating a new object 1011 while the old object is in use and later deleting the object 1012. The regeneration may request a status condition from the application or another object such as “pause” 1013. The regeneration process may comprise regeneration of multiple related objects 1008.

Other forms of regeneration controls include: hierarchical, time based, event based, frequency of use based for example.

While the preferred embodiment of the invention has been illustrated and described herein, it is to be understood that the invention is not limited to the precise construction herein disclosed, and the right is “reserved” to all changes and modifications coming within the scope of the invention as defined in the appended claims.

What is claimed is:

1. A method for managing regeneration of pooled objects in object oriented programming, the method comprising the steps of:
receiving a request for regeneration of a first pooled object;
obtaining first predefined regeneration criteria, the first predefined regeneration criteria defining the conditions for regeneration of the first pooled object;
obtaining first status information, the first status information indicating the status of said first pooled object;
creating a first regeneration process from the first predefined regeneration criteria using the first status information; and
regenerating the first pooled object based on the first regeneration process.

2. The method according to claim 1 wherein the first regeneration process permits regeneration when the first pooled object is marked “free”.

3. The method according to claim 1 wherein the first regeneration process permits regeneration when the first pooled object is marked “reserved”.

4. The method according to claim 1 wherein the first regeneration process comprises the further steps of:
generation of a second pooled object when the first pooled object is marked “reserved”; and
discarding the first pooled object when the first pooled object is marked “free”.

5. The method according to claim 1 wherein the first regeneration process permits regeneration of the first pooled object and a second pooled object when both pooled objects are “free”.

6. The method according to claim 1 wherein the first regeneration process permits regeneration the first pooled object based on a first version number associated with the first pooled object.

7. The method according to claim 6 wherein the first regeneration process permits regeneration when the first version number of the first pooled object is any one of greater than, equal to and less than a predefined second version number.

8. The method according to claim 1 wherein the first regeneration process permits regeneration of the first pooled object based on a regeneration hierarchy.

9. The method according to claim 8 wherein the regeneration hierarchy represents a sequence number associated with the first pooled object wherein the first pooled object is regenerated based on whether the sequence number associated with the first pooled object is any one of less than, equal to and greater than a predefined regeneration sequence number.

10. The method according to claim 1 wherein the first regeneration process permits regeneration of the first pooled object when the first pooled object and a second pooled object are both marked “free”.

11. The method according to claim 10 wherein the first regeneration process permits regeneration of the first pooled object and the second pooled object when both are marked “free”.

12. The method according to claim 1 wherein a plurality of pooled objects share the same regeneration process.

13. The method according to claim 1 wherein an external event comprising a message from an application program enables regeneration of the first pooled object.

14. The method according to claim 1 wherein the first pooled object is a pseudo object that represents a plurality of pooled objects.

15. A system for managing regeneration of pooled objects in object oriented programming, the system comprising:
a receiver for receiving a request for regeneration of a first pooled object;
a first obtainer for obtaining first predefined regeneration criteria, the first predefined regeneration criteria defining the conditions for regeneration of the first pooled object;
a second obtainer for obtaining first status information, the first status information indicating the status of said first pooled object;
a creator for creating a first regeneration process from first predefined regeneration criteria wherein the first predefined regeneration criteria is uniquely associated with the first pooled object; and
a regenerator for regenerating the first pooled object based on the first regeneration process.

16. The system according to claim 15 wherein the first regeneration process permits regeneration when the first pooled object is marked “free”.

17. The system according to claim 15 wherein the first regeneration process permits regeneration when the first pooled object is marked “reserved”.

18. The system according to claim 15 wherein the first regeneration process creator further comprises:
a generator for generation of a second pooled object when the first pooled object is marked “reserved”; and
a discarder for discarding the first pooled object when the first pooled object is marked “free”.

19. The system according to claim 15 wherein the first regeneration process permits regeneration of the first pooled object and a second pooled object when both pooled objects are “free”.

20. The system according to claim 15 wherein the first regeneration process permits regeneration the first pooled object based on a first version number associated with the first pooled object.

21. The system according to claim 20 wherein the first regeneration process permits regeneration when the first version number of the first pooled object is any one of greater than, equal to and less than a predefined second version number.

22. The system according to claim 15 wherein the first regeneration process permits regeneration of the first pooled object based on a regeneration hierarchy.

23. The system according to claim 22 wherein the regeneration hierarchy represents a sequence number associated with the first pooled object wherein the first pooled object is regenerated based on whether the sequence number associated with the first pooled object is any one of less than, equal to and greater than a predefined regeneration sequence number.

24. The system according to claim 15 wherein the first regeneration process permits regeneration of the first pooled object when the first pooled object and a second pooled object are both marked “free”.

25. The system according to claim 24 wherein the first regeneration process permits regeneration of the first pooled object and the second pooled object when both are marked “free”.

26. The system according to claim 15 wherein a plurality of pooled objects share the same regeneration process.

27. The system according to claim 15 wherein an external event comprising a message from an application program enables regeneration of the first pooled object.

28. The system according to claim 15 wherein the first pooled object is a pseudo object that represents a plurality of pooled objects.

29. A computer program product for managing regeneration of pooled objects in object oriented programming said computer program product comprising a computer readable medium having computer readable program code therein comprising:
computer readable program code for receiving a request for regeneration of a first pooled object;
computer readable program code for obtaining first predefined regeneration criteria, the first predefined regeneration criteria defining the conditions for regeneration of the first pooled object;
computer readable program code for obtaining first status information, the first status information indicating the status of said first pooled object;
computer readable program code for creating a first regeneration process from the first predefined regeneration criteria using the first status information; and
computer readable program code for regenerating the first pooled object based on the first regeneration process.

30. The computer program product according to claim 29 wherein the first regeneration process permits regeneration when the first pooled object is marked “free”.

31. The computer program product according to claim 29 wherein the first regeneration process permits regeneration when the first pooled object is marked “reserved”.

32. The computer program product according to claim 29 wherein the first regeneration process further comprises:
computer readable program code for generation of a second pooled object when the first pooled object is marked “reserved”; and
computer readable program code for discarding the first pooled object when the first pooled object is marked “free”.

33. The computer program product according to claim 29 wherein the first regeneration process permits regeneration of the first pooled object and a second pooled object when both pooled objects are “free”.

34. The computer program product according to claim 29 wherein the first regeneration process permits regeneration the first pooled object based on a first version number associated with the first pooled object.

35. The computer program product according to claim 29 wherein the first regeneration process permits regeneration when the first version number of the first pooled object is any one of greater than, equal to and less than a predefined second version number.

36. The computer program product according to claim 29 wherein the first regeneration process permits regeneration of the first pooled object based on a regeneration hierarchy.

37. The computer program product according to claim 36 wherein the regeneration hierarchy represents a sequence number associated with the first pooled object wherein the first pooled object is regenerated based on whether the sequence number associated with the first pooled object is any one of less than, equal to and greater than a predefined regeneration sequence number.

38. The computer program product according to claim 29 wherein the first regeneration process permits regeneration of the first pooled object when the first pooled object and a second pooled object are both marked “free”.

39. The computer program product according to claim 38 wherein the first regeneration process permits regeneration of the first pooled object and the second pooled object when both are marked “free”.

40. The computer program product according to claim 29 wherein a plurality of pooled objects share the same regeneration process.

41. The computer program product according to claim 29 wherein an external event comprising a message from an application program enables regeneration of the first pooled object.

42. The computer program product according to claim 29 wherein the first pooled object is a pseudo object that represents a plurality of pooled objects.
